(19) United States
(12) Patent Application Publication
(10) Pub. No.: US 2020/0282888 A1
(43) Pub. Date: Sep. 10, 2020

(54) HEAD RESTRAINT FOR A SEAT BACK OF A VEHICLE SEAT AND VEHICLE SEAT

(71) Applicant: ADIENT ENGINEERING AND IP GMBH, BURSCHEID (DE)

(72) Inventors: THOMAS GUNKEL, RATINGEN (DE); RUDOLF WILHELM HEMMELRATH, LEVERKUSEN (DE); LAURENCE FINNEGAN, KOELN (DE); ANDREAS SCHMITZ, BURSCHEID (DE); THOMAS FROTZ, WERMELSKIRCHEN (DE); DANIEL BAHR, KUERTEN (DE); KAUSHAL KUMAR SINGH, UTTAR PRADESH (IN)

(73) Assignee: ADIENT ENGINEERING AND IP GMBH, BURSCHEID (DE)

(21) Appl. No.: 16/646,680

(22) PCT Filed: Sep. 11, 2018
(86) PCT No.: PCT/EP2018/074370

§ 371 Date: Mar. 12, 2020

(30) Foreign Application Priority Data
Sep. 12, 2017 (DE) 10 2017 216 116.7

(51) Int. Cl. B60N 2/879; B60N 2/865; B60N 2/809; B60N 2/838

(52) U.S. Cl. CPC B60N 2/879; B60N 2/838; B60N 2/809; B60N 2/865

(57) ABSTRACT

A head restraint for a seat back of a vehicle seat may have two lateral wings. A topmost surface of the wings may flare from top to bottom in a driving position.

The invention relates to a head restraint for a seat back of a vehicle seat, and to a vehicle seat.

In the prior art, head restraints for vehicle seats are known from WO 2018/034903 A1, WO 2017/160594 A1 and US 2017/0224117 A.

The object of the present invention is to specify an improved head restraint for a seat back of a vehicle seat as well as an improved vehicle seat.

Concerning the head restraint, the object is achieved according to the invention by a head restraint for vehicle seats with the features specified in claim 1.

Concerning the vehicle seat, the object is achieved according to the invention by the features specified in claim 8.

The head restraint is particularly suitable for vehicle seats, in particular for driver's seats, which are positionable in a comfort position or in a driving position, wherein a seat back of the vehicle seat can be brought from the comfort position into the driving position, and vice versa. A comfort position is, for example, a lying position of the seat back adopted during a driving state of an autonomously driving vehicle; a driving position of the vehicle seat is a largely upright position of the seat back usually adopted when the driving operation is performed by a human.

A head restraint for a seat back of a vehicle seat has two lateral, that is to say laterally projecting, wings. According to the invention, an upper surface of the wings runs as it increasingly projects from top to bottom, in a driving position, that is to say in an upright position of the head restraint and thus in an upright position of the seat back.

As a result, the head restraint has a shape that satisfies the needs to be expected concerning seating comfort in autonomously driving vehicles. The shape of the lateral wings makes it possible to laterally support a head of a person. Indeed, this shape of the lateral wings of the head restraint makes it possible to laterally support the head, however a peripheral vision of the person is not impaired, in particular when the person is driving the vehicle in which the head restraint is arranged.

A refinement of the head restraint according to the invention provides a number of reading lights. This is particularly advantageous since a light emitted by the reading lights is alignable or aligned particularly well, such that a book, for example, which is being read by a person using the head restraint, is illuminable or illuminated in a particularly targeted manner, since the position of the book held by the person generally corresponds to the position of the head of said person and the position of the head corresponds to the position of the head restraint. Moreover, reading lights usually arranged in a vehicle roof lining can be dispensed with, which is structurally simpler and esthetically more attractive. It is particularly advantageous that, when the position of the head in the vehicle changes, with a corresponding adjustment of the position of the head restraint in the vehicle, the light for reading is always emitted to the desired location, without the lighting direction having to be set separately. This is in particular also the case when the seat back is adjusted, or even when the vehicle seat as a whole is rotated about a vertical axis. By way of the exact alignment, a light for reading is alignable particularly well and thus the reading light is particularly energy-saving, as a result of which an emission of carbon dioxide is reducible. Moreover, other occupants of the vehicle are thereby dazzled to a lesser extent than when using conventional head restraints and separate reading lights.

The reading lights are preferably integrated in the lateral wings. As a result, said reading lights are protected, visually scarcely discernible and thus perceived as esthetic, and, in terms of the illumination direction thereof, are coupled particularly reliably to the position of the head restraint.

The reading lights are particularly preferably integrated in the bottom side of the lateral wings. As a result, a good alignment of the light emitted by the reading lights onto an object to be illuminated is possible in a structurally simple manner.

A further refinement of the head restraint according to the invention provides a number of loudspeakers. As a result, it is possible for directed sound to be provided individually to the seat and thus to the person without requiring the use of headphones, which is possibly perceived as uncomfortable, and whereupon other occupants of the vehicle are disturbed by the exposure to the sound to a lesser extent than when the interior of the vehicle as a whole is exposed to sound in an undirected manner.

These loudspeakers are preferably integrated in the lateral wings. Sound exposure is thus possible in a particularly targeted manner, since the wings are located in the direct vicinity of ears to be exposed to sound. As a result, the loudspeakers are configurable in a low-power and thus small and space-saving manner.

The loudspeakers are particularly preferably integrated in the bottom side of the lateral wings, for example with a common unit comprising both loudspeakers and reading lights. As a result of the fact that the loudspeakers and/or the reading lights are integrated in the bottom side of the lateral wings, they are visually scarcely discernible, as a result of which an esthetic effect can be achieved.

A further refinement of the head restraint according to the invention provides a number of microphones. As a result, a directed voice input which is individual to the seat and thus to the person is possible, for example for making phone calls or for operating a device or the vehicle, whereupon other occupants of the vehicle are disturbed by the voice input to a lesser extent than if microphones arranged further away were used.

A vehicle seat has a seat back. According to the invention, an above-described head restraint is provided. The vehicle seat has the aforementioned advantages; in particular, a person sitting on the vehicle seat can always illuminate an object in a targeted manner and can be exposed to sound in a targeted manner, even if the vehicle seat is adjusted, for example an inclination of the seat back or a positioning of the head restraint is changed, or if the vehicle seat as a whole is rotated about a vertical axis, for example when a comfort position or a driving position is adopted.

A refinement of the vehicle seat according to the invention provides a connecting element for connecting the head restraint to the seat back. This connecting element is at least part of an adjustment mechanism for adjusting the head restraint. The connecting element is displaceable with respect to the seat back in the z direction and pivotable about a horizontal axis. As a result, the head restraint is simply and effectively adjustable.

It is preferably provided that the head restraint is linearly, or at least approximately linearly, displaceable with respect to the connecting element at least in part in an x direction, that is to say in the longitudinal direction of the vehicle. As a result, the head restraint can be brought into a wide variety of respectively desired positions particularly well.

Here, the displacement in the z direction, the rotation and the displacement in the x direction are particularly preferably performable simultaneously, as a result of which the adjustment can take place particularly quickly.

A further refinement of the vehicle seat according to the invention provides a rotatability of the vehicle seat with respect to a vehicle floor about a vertical axis. As a result, the vehicle seat can be brought in a simple manner from a comfort position into a driving position, and vice versa.

According to a further refinement of the vehicle seat according to the invention, it is provided that the displaceability in the z direction amounts to between 60 mm and 80 mm, in particular between 65 mm and 75 mm, and/or the rotatability about the horizontal axis amounts to between 5° and 9°, in particular between 6° and 8°, and/or the displaceability in the x direction amounts to between 20 mm and 40 mm, in particular between 25 mm and 35 mm. As a result, the head restraint can be brought particularly well into a wide variety of respectively desired positions and the vehicle seat is thus particularly comfortable.

According to a further refinement of the vehicle seat according to the invention, a so-called spine design is provided, wherein the connecting element comprises a single, that is to say unsegmented, trim, which may be of a single-part or multi-part form. The single trim has a very pleasant visual appearance in comparison with a conventional connection between the seat back and the vehicle seat by means of two rods.

The exemplary embodiments of the inventions are explained in more detail with reference to the drawings, in which:

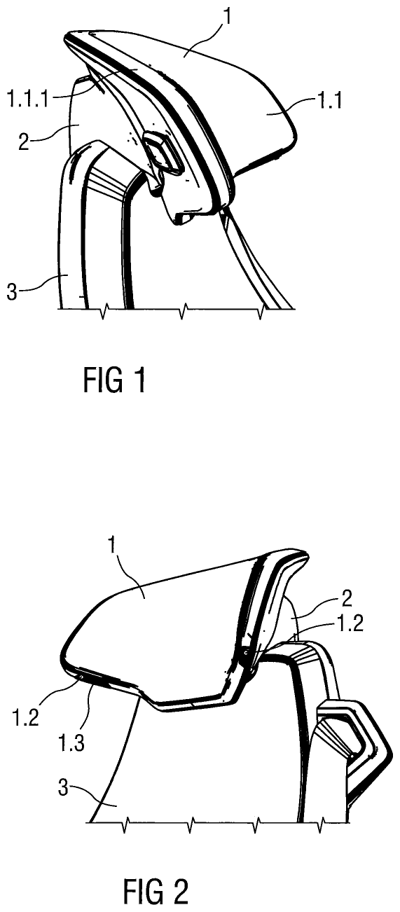

FIG. 1 shows an embodiment of a head restraint according to the invention in a perspective view,

FIG. 2 shows an associated further perspective view,

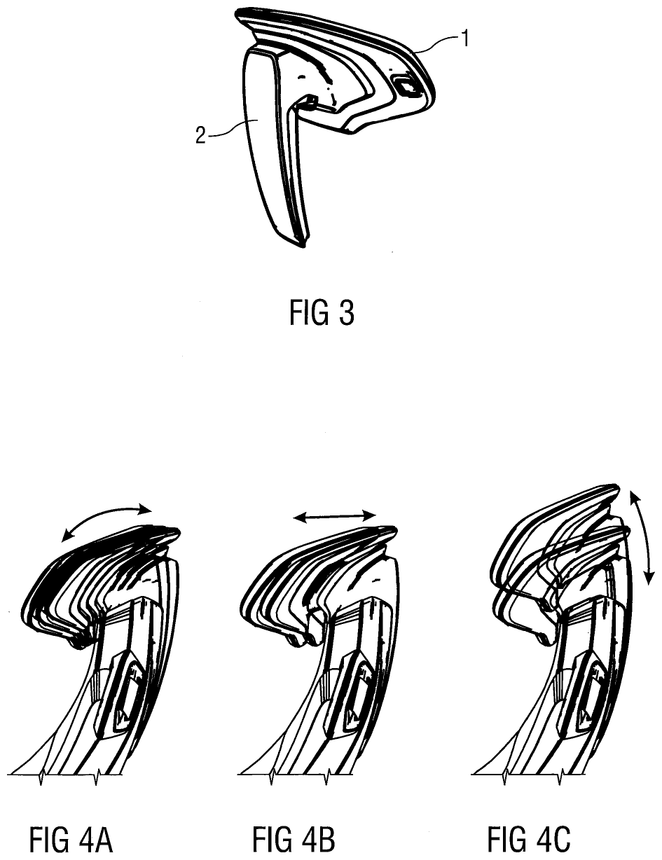

FIG. 3 shows an associated further perspective view, and

FIGS. 4a to 4c show associated further perspective views.

Mutually corresponding parts are provided with identical reference signs in all of the figures.

FIGS. 1 to 3 and 4a, 4b and 4c show a head restraint 1 according to the invention. The head restraint 1 has a shape that satisfies the needs to be expected concerning seating comfort in autonomously driving vehicles. The shape of the lateral wings 1.1 is configured such that it is possible to laterally support a head of a person. These lateral wings 1.1 of the head restraint 1 are shaped such that it is indeed made possible to laterally support the head, but a peripheral vision of the person is not impaired, in particular when the person is driving the vehicle in which the head restraint is arranged.

The head restraint 1 for the seat back 3 of the vehicle seat has two lateral, that is to say laterally projecting, wings 1.1. Here, an upper surface 1.1.1 of the wings 1.1 runs from top to bottom as it increasingly projects in a driving position, that is to say in an upright position of the head restraint 1 and thus in an upright position of the seat back 3. The surface 1.1.1 of the wings 1.1 thus slopes from the inside to the outside, specifically less strongly in a top region, that is to say in the region of relatively small projection, than in a bottom region, that is to say in the region of relatively great projection.

Two reading lights 1.2 and a loudspeaker system with two loudspeakers 1.3 are integrated in the head restraint 1. The reading lights 1.2, the loudspeakers 1.3 of the loudspeaker system and an optional microphone are always perfectly positioned in this case, in particular independently of a position of the head restraint 1 with respect to the seat back 3 of the vehicle seat and independently of a position of the vehicle seat in the vehicle, for example even in the case of a deeply folded-down seat back 3 or in the case of a vehicle seat rotated by 180° about the vertical axis. The head restraint 1 allows for an improvement of an adjustment range in order to make it possible to support the head of the person, even in a deeply reclined position. At the same time, the requirements resulting from spatial restrictions are taken into account by virtue of the fact that a slender adjustment mechanism is used, which is arranged at least in part in a connecting element 2.

A reading light 1.2 and a loudspeaker 1.3 are arranged in a common unit in each lateral wing 1.1.

An adjustment, shown in FIGS. 4a and 4b, of the head restraint 1 in the x direction is made possible by an, in particular electrically driven, adjustment of the head restraint 1, an adjustment in the x direction by 30 mm by way of turning the head restraint by 7° being combinable with an additional displacement by 30 mm in the x direction as a linear displacement.

An adjustment mechanism, illustrated in FIG. 4c, for an adjustment of the head restraint 1 in the z direction uses a space in the top region of the seat back 3 to which the head restraint 1 is assigned. The arrangement of the adjustment mechanism for the adjustment in the z direction in the top region of the seat back 3 allows a greater freedom of design, in particular a so-called spine design instead of two simple conventional rods, the appearance of which could be regarded as outdated. The head restraint is adjustable in height, that is to say in the z direction, by 70 mm.

### LIST OF REFERENCE SIGNS

1 Head restraint
1.1 Lateral wings
1.1.1 Upper surface
1.2 Reading light
1.3 Loudspeaker
2 Connecting element
3 Seat back

1-13. (canceled)

14. A head restraint for a seat back of a vehicle seat, comprising:
two lateral wings, wherein in a driving position, an upper surface of the wings runs with an increasing projection from top to bottom.

15. The head restraint as claimed in claim 14, further comprising a number of reading lights.

16. The head restraint as claimed in claim 15, wherein the reading lights are integrated in the lateral wings.

17. The head restraint as claimed in claim 16, wherein the reading lights are integrated in the bottom side of the lateral wings.

18. The head restraint as claimed in claim 14, further comprising a number of loudspeakers and/or a number of microphones.

19. The head restraint as claimed in claim 18, wherein the loudspeakers and/or the microphones are integrated in the lateral wings.

20. The head restraint as claimed in claim 19, wherein the loudspeakers and/or the microphones are integrated in the bottom side of the lateral wings.

21. A vehicle seat, comprising:
a seat back, and a head restraint comprising two lateral wings, wherein in a driving position, an upper surface of the wings runs with an increasing projection from top to bottom.

22. The vehicle seat as claimed in claim 21, further comprising a connecting element for connecting the head restraint to the seat back, wherein the connecting element is at least part of an adjustment mechanism and wherein the connecting element is displaceable with respect to the seat back in the z direction and pivotable about a horizontal axis.

23. The vehicle seat as claimed in claim 21, wherein the head restraint is linearly displaceable with respect to the connecting element at least in part in an x direction.

24. The vehicle seat as claimed in claim 23, wherein the displacement in the z direction, the rotation and the displacement in the x direction are performable simultaneously.

25. The vehicle seat as claimed in claim 21, further comprising a rotatability about a vertical axis.

26. The vehicle seat as claimed in claim 23, wherein
the displaceability in the z direction amounts to between 60 mm and 80 mm; and/or
the rotatability about the horizontal axis amounts to between 5° and 9°; and/or
the displaceability in the x direction amounts to between 20 mm and 40 mm.
